(19) United States
(12) Patent Application Publication
(10) Pub. No.: US 2026/0319959 A1
(43) Pub. Date: Oct. 15, 2026

(54) COMPUTING SYSTEM INCLUDING PREFETCH ENGINE AND OPERATING METHOD THEREOF

(71) Applicant: Samsung Electronics Co., Ltd., Suwon-si (KR)

(72) Inventors: Youngsik Lee, Suwon-si (KR); Changho Ryu, Suwon-si (KR); Tae Hee Han, Suwon-si (KR)

(73) Assignees: Samsung Electronics Co., Ltd., Suwon-si (KR); Research & Business Foundation Sungkyunkwan University, Suwon-si (KR)

(21) Appl. No.: 19/271,265

(22) Filed: Jul. 16, 2025

(30) Foreign Application Priority Data
Apr. 9, 2025 (KR) 10-2025-0046401
May 14, 2025 (KR) 10-2025-0062828

(51) Int. Cl. G06F 12/0862

(52) U.S. Cl. CPC G06F 12/0862; G06F 2212/602

(57) ABSTRACT

An operating method of a computing system includes generating an inverted program counter by performing a bit inversion operation on a program counter, generating input data by performing an XOR operation based on a first address and the inverted program counter, performing a prefetch address prediction operation based on the input data by using a trained binary temporal convolutional neural network, and selectively performing data prefetch from a memory device to a cache memory based on a result of the prefetch address prediction operation, wherein the binary temporal convolutional neural network is trained based on a position delta map including an escape delta set and a proximity delta set.

### CROSS-REFERENCE TO RELATED APPLICATIONS

This application claims priority to and the benefit under 35 U.S.C. § 119 (a)-(d) of Korean Patent Application No. 10-2025-0046401, filed on Apr. 9, 2025, and Korean Patent Application No. 10-2025-0062828, filed on May 14, 2025, in the Korean Intellectual Property Office, the entire disclosures of which are incorporated herein by reference.

### BACKGROUND

The discloure relates to a semiconductor integrated circuit, and more particularly, to a computing system including a prefetch engine, and a method of operating the computing system.

A data prefetch operation plays a critical role in alleviating memory hierarchy bottlenecks and improving Instructions Per Cycle (IPC) through its capability to detect and predict complex memory access patterns. However, there exist limitations of prefetch engines that use predefined heuristics or rule-based approaches.

### SUMMARY

The inventive concept provides a computing system including a prefetch engine with improved performance, and a method of operating the computing system.

According to an aspect of the inventive concept, there is provided an operating method of a computing system, the operating method including generating an inverted program counter by performing a bit inversion operation on a program counter, generating input data by performing an XOR operation based on a first address and the inverted program counter, performing a prefetch address prediction operation based on the input data by using a trained binary temporal convolutional neural network, and selectively performing data prefetch from a memory device to a cache memory based on a result of the prefetch address prediction operation, wherein the binary temporal convolutional neural network is trained based on a position delta map including an escape delta set and a proximity delta set.

According to another aspect of the inventive concept, there is provided a computing system including a memory device, a cache memory, at least one processor, and a prefetch engine, wherein the prefetch engine includes a bit inversion circuit configured to receive a program counter and perform a bit inversion operation on the program counter to generate an inverted program counter, an operation circuit configured to generate input data by performing an XOR operation based on the inverted program counter and a first address, a binary temporal convolutional neural network model configured to receive the input data, perform a neural network operation based on the input data, and output a prediction delta, and a filter circuit configured to generate a prefetch address based on the prediction delta and an address when the prediction delta indicates a proximate position index, and configured not to generate a prefetch address when the prediction delta indicates an escape index, wherein the binary temporal convolutional neural network is trained based on a position delta map including an escape delta set and a proximity delta set, and data is loaded from the memory device to the cache memory based on the prefetch address.

According to another aspect of the inventive concept, there is provided an operating method of a computing system, the operating method including generating an inverted program counter by performing a bit inversion operation on a program counter, generating input data by performing an XOR operation based on a first address and the inverted program counter, generating a prediction delta based on the input data by using a trained binary temporal convolutional neural network, and generating a prefetch address and performing data prefetch from a memory device to a cache memory based on the prefetch address, when the prediction delta indicates a proximate position index, and skipping data prefetch when the prediction delta indicates an escape index, wherein the binary temporal convolutional neural network is trained based on a position delta map including an escape delta set and a proximity delta set.

According to aspects of the disclosure provided is a non-transitory computer readable medium on which is stored a computer program which when implemented by a processor causes the processor to: generate an inverted program counter by performing a bit inversion operation on a program counter; generate input data by performing an XOR operation based on a first address and the inverted program counter; perform a prefetch address prediction operation based on the input data by using a trained binary temporal convolutional neural network; and selectively perform data prefetch from a memory device to a cache memory based on a result of the prefetch address prediction operation, wherein the binary temporal convolutional neural network is trained based on a position delta map including an escape delta set and a proximity delta set.

### BRIEF DESCRIPTION OF THE DRAWINGS

Embodiments will be more clearly understood from the following detailed description taken in conjunction with the accompanying drawings in which:

FIG. 1 is a block diagram illustrating a computing system according to embodiments;

FIG. 2 is a block diagram illustrating a prefetch engine of FIG. 1 in detail according to embodiments;

FIG. 3 is a diagram for describing an operation of the prefetch engine of FIG. 1 according to embodiments;

FIG. 4 is a diagram for describing a position delta map according to embodiments;

FIGS. 5A and 5B are diagrams illustrating a position delta map according to embodiments;

FIG. 6 is a flowchart showing an example of a method of operating the computing system of FIG. 1, according to embodiments;

FIG. 7 is a block diagram illustrating a neural network model of FIG. 1 in detail according to embodiments;

FIG. 8 is a flowchart showing an example of a method of operating the computing system of FIG. 1, according to embodiments;

FIG. 9 is a flowchart showing an example of a method of operating the computing system of FIG. 1, according to embodiments;

FIG. 10 is a flowchart showing operation S240 of FIG. 9 in detail according to embodiments;

FIG. 11 is a flowchart showing operation S241 of FIG. 10 in detail according to embodiments;

FIGS. 12A and 12B are block diagrams illustrating a computing system according to embodiments;

FIG. 13 is a block diagram illustrating the prefetch engine of FIG. 1 in detail according to embodiments;

FIG. 14 is a flowchart showing an example of a method of operating a computing system, according to embodiments;

FIG. 15 is a flowchart showing an example of a method of operating a computing system, according to embodiments;

FIG. 16 is a block diagram illustrating the prefetch engine of FIG. 1 in detail according to embodiments;

FIG. 17 is a diagram for describing a hash address according to embodiments;

FIG. 18 is a block diagram illustrating the prefetch engine of FIG. 1 in detail according to embodiments;

FIG. 19 is a block diagram illustrating a computing system including a memory storing a program, according to embodiments; and

FIG. 20 is a block diagram illustrating a computing system that accesses a storage medium storing a program, according to embodiments.

### DETAILED DESCRIPTION

Hereinafter, embodiments will be described clearly and in detail to such an extent that a person skilled in the art may easily work the inventive concept.

A prefetch engine with improved performance is required, which is flexible enough to adapt to various application environments even when memory access patterns are irregular.

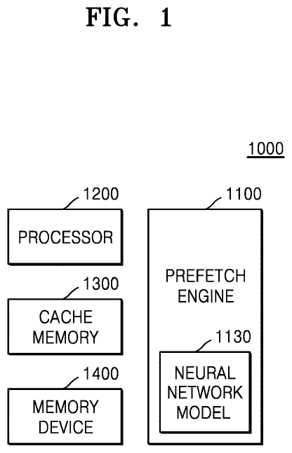

FIG. 1 is a block diagram illustrating a computing system according to embodiments.

Referring to FIG. 1, a method of generating or training a neural network model and performing data prefetch by using the neural network model is described. A computing system 1000 may include a prefetch engine 1100, a processor 1200, a cache memory 1300, and a memory device 1400. The prefetch engine 1100 may include a neural network model 1130. The computing system 1000 may be a stationary computing system, such as a desktop computer, a workstation, a server, or a portable computing system, such as a laptop computer.

The computing system 1000 may refer to a data processing device capable of processing data, such as a central processing unit (CPU), a processor, a microprocessor, or an application processor (AP). The computing system 1000 may execute an operating system (OS) and/or various applications.

The processor 1200 may control the overall operation of the computing system 1000. In embodiments, the processor 1200 may include a CPU. In embodiments, the processor 1200 may transmit a request to the cache memory 1300 and the memory device 1400. The processor 1200 may transmit a write request for data generated through an operation, to the cache memory 1300 and the memory device 1400. The processor 1200 may transmit a read request for data required for operation to the cache memory 1300 and the memory device 1400.

The cache memory 1300 may store a portion of data stored in the memory device 1400. The cache memory 1300 may be implemented as a volatile memory (e.g., static random-access memory (SRAM)), but the inventive concept is not limited thereto. For example, the cache memory 1300 may be a last level cache directly connected to the memory device 1400. In embodiments, the cache memory 1300 may temporarily store instructions and/or data needed by the processor 1200.

The computing system 1000 may further include a plurality of caches (not shown). For example, the plurality of caches and the cache memory 1300 may be hierarchically connected to each other. The plurality of caches and the cache memory 1300 may be connected to each other in series between the memory device 1400 and the processor 1200. For example, among the plurality of caches, a cache directly connected to the processor 1200 may be a top-level cache.

The memory device 1400 may store data used by the processor 1200. The memory device 1400 may include volatile memory, such as SRAM, dynamic random-access memory (DRAM), etc. However, the inventive concept is not limited thereto, and the memory device 1400 may include any type of memory accessible to the processor 1200, such as a non-volatile memory such as flash memory, phase-change random access memory (PRAM), magnetic random-access memory (MRAM), or ferroelectric random-access memory (FeRAM).

The computing system 1000 may perform data prefetch. The computing system 1000 may prefetch data expected to be used by the processor 1200, from the memory device 1400 to the cache memory 1300. The computing system 1000 may perform a prefetch operation. A prefetch operation may refer to an operation of loading data expected to be accessed by the processor 1200, from the memory device 1400 into the cache memory 1300 in advance.

The prefetch engine 1100 may perform a prefetch predicting operation. A prefetch predicting operation may refer to an operation of predicting a prefetch address by using a neural network model (e.g., a binary-temporal convolutional neural network model). For example, the prefetch engine 1100 may predict an address for which a prefetch request will be made in the cache memory 1300.

The prefetch engine 1100 may predict a prefetch address. A prefetch address may indicate an address that the processor 1200 is expected to access. Alternatively, the prefetch address may indicate an address corresponding to data to be prefetched from the memory device 1400 to the cache memory 1300. The prefetch engine 1100 may generate a prefetch address.

The prefetch engine 1100 may determine whether to perform a prefetch operation. The prefetch engine 1100 may determine whether to perform a prefetch operation, based on output data of the neural network model 1130. For example, the output data may be a prediction delta. The prediction delta may indicate a difference between a likely accessible prefetch address and a reference address. The prediction delta may indicate an escape index or a proximate position index.

The prefetch engine 1100 may skip data prefetch if the prediction delta indicates an escape index. The prefetch engine 1100 may not generate a prefetch address when it is determined to skip a prefetch operation. The prefetch engine 1100 may generate a prefetch address when it is determined perform a prefetch operation.

The prefetch engine 1100 may perform a prefetch operation. The prefetch engine 1100 may load data corresponding to the prefetch address expected to be accessed by the processor 1200, from the memory device 1400 to the cache memory 1300. The prefetch engine 1100 may read data predicted to be used by the processor 1200, from the memory device 1400. The prefetch engine 1100 may skip a prefetch operation. The prefetch engine 1100 may not perform a prefetch operation.

The computing system 1000 may generate the neural network model 1130. The computing system 1000 may train the neural network model 1130. The computing system 1000 may perform data prefetch using the trained neural network model 1130. In embodiments, the neural network model 1130 may be a binary temporal convolutional neural network model.

The computing system 1000 may include at least one processor and a non-transitory storage medium storing instructions that, when executed by the at least one processor, cause the at least one processor to train the neural network model 1130 and perform data prefetch using the neural network model 1130.

Below, various operations performed by the at least one processor of the computing system 1000 may be directly implemented as hardware, a software module executed by the processor, or a combination thereof. When implemented as software, functions may be stored as one or more instructions or code on a tangible, non-transitory storage medium. A software module may be in random access memory (RAM), flash memory, read only memory (ROM), electrically programmable ROM (EPROM), electrically erasable programmable ROM (EEPROM), registers, a hard disk, a removable disk, a CD ROM, or any other form of storage medium.

For example, the neural network model 1130 may be implemented in a standalone computing system or in distributed computing systems that may communicate with each other via a network or the like. Additionally, the neural network model 1130 may include a portion implemented by a processor executing a program including a series of instructions, or may include a portion implemented by logic hardware designed by logic synthesis. In this specification, a processor may refer to any hardware-implemented data processing device that includes circuitry physically structured to execute predefined operations including operations expressed in instructions and/or code included in a program. For example, the data processing device may include a microprocessor, a CPU, a graphics processing unit (GPU), a neural processing unit (NPU), a processor core, a multi-core processor, a multi-processor, an application-specific integrated circuit (ASIC), an application-specific instruction-set processor (ASIP), and a field programmable gate array (FPGA).

The neural network model 1130 may be implemented in the computing system 1000 to predict a prefetch address. For example, the neural network model 1130 may receive input data and output a prediction delta. The input data may be generated by performing an XOR operation on an address and an inverted program counter. The prediction delta may indicate a difference between a likely accessible prefetch address and a reference address. The prediction delta may indicate an escape index or a proximate position index. Accordingly, the complexity of the neural network model may be alleviated, the accuracy of prefetch address prediction may be improved, the computational performance of the neural network model may be improved, the instructions per cycle (IPC) may be improved, and system resources may be used efficiently.

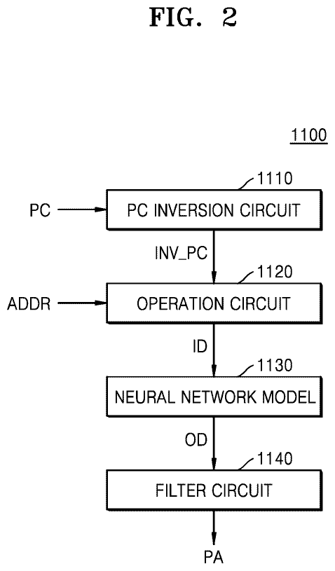

FIG. 2 is a block diagram illustrating the prefetch engine of FIG. 1 in detail according to embodiments.

Referring to FIGS. 1 and 2, the prefetch engine 1100 may include a program counter (PC) inversion circuit 1110, an operation circuit 1120, the neural network model 1130, and a filter circuit 1140.

The PC inversion circuit 1110 may receive a program counter PC. The PC inversion circuit 1110 may perform a bit inversion operation on the program counter PC. The PC inversion circuit 1110 may perform a bit inversion operation on the program counter PC to generate an inverted program counter INV_PC. The PC inversion circuit 1110 may transmit the inverted program counter INV_PC to the operation circuit 1120.

A bit inversion operation may refer to an operation of flipping bits in reverse order with respect to the program counter PC. For example, the bit inversion operation may include a bit reverse operation. That is, the bit inversion operation may refer to an operation of reconstructing an order of bits by reversing the order of bits. Alternatively, the bit inversion operation may refer to an operation of flipping the position of a bit string left or right. For example, when a bit string is arranged in the order of a[6], a[5], a[4], a[3], a[2], and a[1], the bit strings may be rearranged in the order of a[1], a[2], a[3], a[4], a[5], and a[6] by performing a bit inversion operation. Assuming the program counter PC is ‘001110’, the inverted program counter INV_PC may be ‘011100’.

The operation circuit 1120 may receive an address ADDR and the inverted program counter INV_PC. The operation circuit 1120 may be an XOR operation unit or an XOR operation circuit. The operation circuit 1120 may generate input data by performing an XOR operation based on the address ADDR and the inverted program counter INV_PC. For example, the operation circuit 1120 may generate input data ID by performing an XOR operation on the address ADDR and the inverted program counter INV_PC. The operation circuit 1120 may transmit the input data ID to the neural network model 1130.

The neural network model 1130 may receive the input data ID. The neural network model 1130 may output output data OD. The output data OD may be a prediction delta PD. The prediction delta PD may refer to a difference or offset between the address ADDR and a prefetch address, which is an address that the processor 1200 is expected to access. The neural network model 1130 may transmit the output data OD to the filter circuit 1140.

The filter circuit 1140 may receive the output data OD and the address ADDR. The filter circuit 1140 may perform a filtering operation based on the output data OD. The filtering operation may refer to an operation that does not generate a prefetch address if the prediction delta indicates an escape index, and generates a prefetch address if the prediction delta indicates a proximate position index. The filter circuit 1140 may determine whether to perform a prefetch operation. A prefetch address may be generated based on the output data OD of the filter circuit 1140.

In embodiments, the filter circuit 1140 may skip data prefetch without generating a prefetch address if a prediction delta indicates any one of escape indices (E1, E2). In embodiments, the filter circuit 1140 may generate a prefetch address if the prediction delta indicates any one of proximate position indices P1 to P6.

In embodiments, the filter circuit 1140 may generate a prefetch address. The filter circuit 1140 may generate a prefetch address based on the address ADDR and the output data OD (or a prediction delta). The filter circuit 1140 may generate a prefetch address by adding the address ADDR and the prediction delta.

In embodiments, the filter circuit 1140 may transmit the prefetch address to a cache manager (not shown). Alternatively, the filter circuit 1140 may transmit a prefetch request including the prefetch address to the cache manager. For example, the cache manager may perform a prefetch operation based on the prefetch address. The cache manager may load data corresponding to the prefetch address from the memory device 1400 into the cache memory 1300. In embodiments, the filter circuit 1140 may transmit a read request including the prefetch address to the memory device 1400. In response to the read request, data corresponding to the prefetch address stored in the memory device 1400 may be loaded into the cache memory 1300.

In embodiments, the prefetch engine 1100 may predict a prefetch address based on the program counter PC and the address ADDR. The prefetch engine 1100 may identify patterns such as branch prediction or loop structures by predicting a prefetch address based on the program counter PC.

When converting an address and a program counter through an embedding layer of a neural network model and then concatenating the results or providing the results to the neural network model as separate inputs, there is a problem that the input dimension of the neural network model increases and the computational complexity increases. In addition, if the address and the program counter are simply combined with each other directly without an embedding layer, a problem occurs in which the low-bit information affects the higher-bit area, which may contaminate or distort the consistency of the actual memory access pattern.

However, the prefetch engine 1100 according to embodiments may input the input data ID that is binary data, into the neural network model 1130. The prefetch engine 1100 may perform a bit inversion operation on the program counter PC to predict a prefetch address based on the inverted program counter INV_PC. The prefetch engine 1100 may generate the input data ID by performing an XOR operation on the inverted program counter INV_PC and the address ADDR. Accordingly, the prefetch engine 1100 may prevent the input dimension of the neural network model 1130 from increasing and maintain entropy. The prefetch engine 1100 may effectively combine the program counter PC with the address ADDR.

When performing a logical operation, such as an AND operation or an OR operation on an address or program counter, a result value of the operation may tend to be biased toward one of ‘0’ or ‘1’. Typically, during the early stage of execution of an application, a value of the program counter PC may consist mostly of ‘0’ in the higher-bit area. The PC inversion circuit 1110 may perform a bit inversion operation on the program counter PC to generate the inverted program counter INV_PC. A lower bit area of the inverted program counter INV_PC may consist mostly of ‘0’. The operation circuit 1120 may generate the input data ID by performing an XOR operation on the inverted program counter INV_PC and the address ADDR. Since the lower bit area of the inverted program counter INV_PC has a high ratio of ‘0’, lower bit information of the address ADDR may be reflected in the input data ID, which is a result after the XOR operation. Accordingly, the input data ID may maintain a lower bit-based, sensitive delta pattern of the address ADDR, thereby minimizing contamination of an address delta pattern.

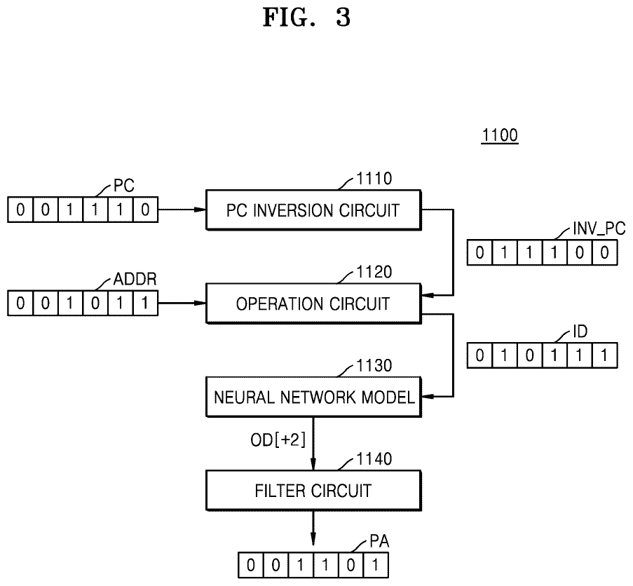

FIG. 3 is a diagram for describing an operation of the prefetch engine of FIG. 1 according to embodiments.

Referring to FIGS. 2 and 3, for example, it is assumed that the program counter PC is ‘001110’, the address ADDR is ‘001011’, and the output data OD is ‘+2’. However, the scope of the inventive concept is not limited thereto. The PC inversion circuit 1110 may perform a bit inversion operation on the program counter PC to generate the inverted program counter INV_PC. The PC inversion circuit 1110 may invert a logic value of each bit of the program counter PC. The inverted program counter INV_PC may be ‘011100’.

The operation circuit 1120 may receive the address ADDR and the inverted program counter INV_PC. The operation circuit 1120 may perform an XOR operation on the address ADDR and the inverted program counter INV_PC. The operation circuit 1120 may generate the input data ID. The input data ID may be ‘010111’.

The neural network model 1130 may output the output data OD. For example, the output data OD may be ‘+2’. The filter circuit 1140 may generate a prefetch address PA based on the output data OD and the address ADDR. Since the filter circuit 1140 indicates ‘+2’ as the output data OD and the address ADDR indicates ‘001011’, the prefetch address PA may be ‘001101’.

The neural network model 1130 may receive binary input data and may be configured with a relatively small number of hidden layers. Computational complexity and inference delay time may be reduced. By generating input data through an XOR operation between an address and an inverted program counter, contamination in a delta pattern, which may occur when binarizing the address and the program counter separately may be alleviated.

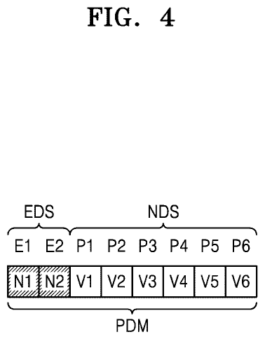

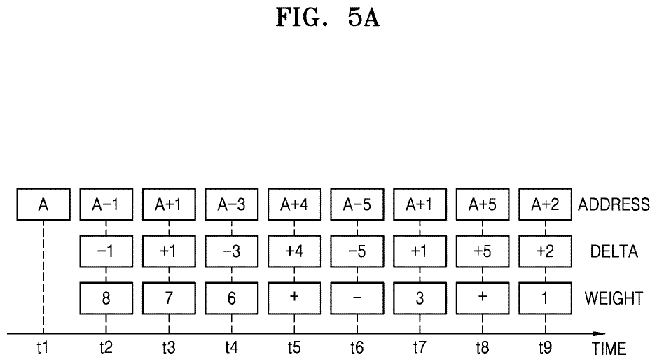

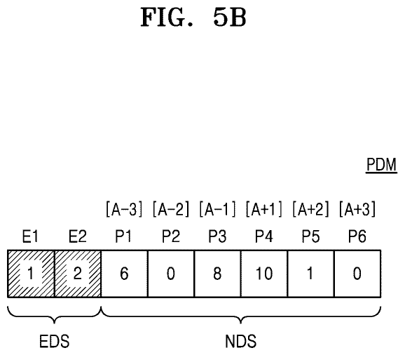

FIG. 4 is a diagram for describing a position delta map according to embodiments. FIGS. 5A and 5B are diagrams illustrating a position delta map according to embodiments.

Referring to FIGS. 1, 4, 5A, and 5B, the computing system 1000 may train the neural network model 1130 based on a position delta map PDM. The position delta map PDM may be a label. The position delta map PDM may include an escape delta set EDS and a proximity delta set NDS. The position delta map PDM may be training data for performing supervised learning for a neural network model according to embodiments.

The proximity delta set NDS may include weights corresponding to addresses in a range within a threshold value relative to an address, and the escape delta set EDS may include counts corresponding to addresses in a range outside the threshold value relative to the address. The weights may be determined based on frequency and temporal proximity.

The computing system 1000 may generate the position delta map PDM. It is assumed that a reference address ADDR indicates ‘A’, the length of a label window is ‘8’, and a delta boundary value is ‘3’. For example, it is assumed that an address at a first time point t1 indicates ‘A’, an address at a second time point t2 indicates ‘A−1’, an address at a third time point t3 indicates ‘A+1’, an address at a fourth time point t4 indicates ‘A−3’, an address at a fifth time point t5 indicates ‘A+4’, an address at a sixth time point t6 indicates ‘A−5’, an address at a seventh time point t7 indicates ‘A+1’, an address at an eighth time point t8 indicates ‘A+5’, and an address at a ninth time point t9 indicates ‘A+2’. The label window and the delta boundary value may be predetermined. For example, the delta boundary value may be a preset threshold.

As the computing system 1000 has a label window of ‘8’, the position delta map PDM may be generated based on eight addresses to be accessed subsequently based on a current address ADDR. For example, the computing system 1000 may generate the position delta map PDM based on an address sequence of ‘A−1 A+1 A−3 A+4 A−5 A+1 A+5 A+2’.

In embodiments, the computing system 1000 may determine a delta corresponding to an address sequence. The computing system 1000 may determine a delta based on a reference address and a current address. The computing system 1000 may determine a difference or offset between the current address and the reference address as a delta. For example, as the address at the second time point t2 is ‘A−1’, a first delta corresponding to the second time point t2 may be ‘−1’. As the address at the third time point t3 is ‘A+1’, a second delta corresponding to the third time point t3 may be ‘+1’. As the address at the fourth time point t4 is ‘A−3’, a third delta corresponding to the fourth time point t4 may be ‘−3’. As the address at the fifth time point t5 is ‘A+4’, a fourth delta corresponding to the fifth time point t5 may be ‘+4’. As the address at the sixth time point t6 is ‘A−5’, a fifth delta corresponding to the sixth time point t6 may be ‘−5’. As the address at the seventh time point t7 is ‘A+1’, a sixth delta corresponding to the seventh time point t7 may be ‘+1’. As the address at the eighth time point t8 is ‘A+5’, a seventh delta corresponding to the eighth time point t8 may be ‘+5’. As the address at the ninth time point t9 is ‘A+2’, an eighth delta corresponding to the ninth time point t9 may be ‘+2’.

In embodiments, the computing system 1000 may determine the weights. The computing system 1000 may set a higher weight the closer to the reference address. For example, the computing system 1000 may set a higher weight value as a temporal interval is closer to the reference address. The computing system 1000 may assign a higher weight value to an address that is temporally closer to the reference address. Accordingly, the importance of addresses with recent access history may be reflected with a relatively high degree. For example, the computing system 1000 may assign a highest weight to an address that is closest in time to the reference address, and a lowest weight to an address that is farthest in time from the reference address. The weight values may be set to decrease linearly with temporal distance or order. Accordingly, prediction accuracy may be improved by increasing the prefetch priority for addresses that are temporally closer.

In embodiments, the computing system 1000 may set a flag instead of setting a weight value if the magnitude (or absolute value) of a delta exceeds a delta boundary value. As the delta boundary value is ‘3’, the computing system 1000 may set a flag when the delta is less than ‘−3’ or when the delta is greater than ‘+3’. For example, the flag may include a first flag (e.g., ‘+’) and a second flag (e.g., ‘−’). The computing system 1000 may set the first flag if the sign of the delta is a positive sign, and may set the second flag if the sign of the delta is a negative sign.

For example, the first delta corresponding to the second time point t2 is ‘−1’, and since the size of the first delta is less than or equal to the delta boundary value (e.g., ‘3’), the computing system 1000 may set a weight corresponding to the second time point t2 as a weight value. The computing system 1000 may set the weight corresponding to the second time point t2 to ‘8’.

In other words, as the address at the second time point t2 is included in a proximity range, the weight corresponding to the second time point t2 may be ‘8’. Here, the proximity range may be greater than or equal to a first value and less than or equal to a second value. The first value may be a value calculated by subtracting the delta boundary value from the reference address, and the second value may be a value calculated by adding the delta boundary value to the reference address.

The second delta corresponding to the third time point t3 is ‘+1’, and since the size of the second delta is less than or equal to the delta boundary value, the computing system 1000 may set the weight corresponding to the third time point t3 to ‘7’. The third delta corresponding to the fourth time point t4 is ‘−3’, and since the size of the third delta is less than or equal to the delta boundary value, the computing system 1000 may set a weight corresponding to the fourth time point t4 to ‘6’. The fourth delta corresponding to the fifth time point t5 is ‘+4’, and since the size of the fourth delta exceeds the delta boundary value, the computing system 1000 may set a flag instead of setting a weight value corresponding to the fifth time point t5. The computing system 1000 may set the weight corresponding to the fifth time point t5 to the first flag (e.g., ‘+’). The fifth delta corresponding to the sixth time point t6 is ‘−5’, and since the size of the fifth delta exceeds the delta boundary value, the computing system 1000 may set the weight corresponding to the sixth time point t6 to the second flag (e.g., ‘−’). The sixth delta corresponding to the seventh time point t7 is ‘+1’, and since the size of the sixth delta is less than or equal to the delta boundary value, the computing system 1000 may set a weight corresponding to the seventh time point t7 to ‘3’. The seventh delta corresponding to the eighth time point t8 is ‘+5’, and since the size of the seventh delta exceeds the delta boundary value, the computing system 1000 may set a weight corresponding to the eighth time point t8 to the first flag (e.g., ‘+’). The eighth delta corresponding to the ninth time point t9 is ‘+2’, and since the size of the eighth delta is less than or equal to the delta boundary value, the computing system 1000 may set a weight corresponding to the ninth time point t9 to ‘1’.

The computing system 1000 may generate the position delta map PDM based on the set weights. The position delta map PDM may include the escape delta set EDS and the proximity delta set NDS. The escape delta set EDS may include frequencies corresponding to escape indices. In embodiments, the escape index may include a first index E1 and a second index E2. The escape delta set EDS may include a first frequency N1 corresponding to the first index E1 and a second frequency N2 corresponding to the second index E2.

In embodiments, the computing system 1000 may classify a delta as either an escape positive index or an escape negative index if the magnitude (or absolute value) of the delta exceeds the delta boundary value. For example, the first index E1 may indicate an escape negative index, and the second index E2 may indicate an escape positive index. The first index E1 may indicate the proportion of positive escape deltas within the label window, and the second index E2 may indicate the proportion of negative escape deltas within the label window. Alternatively, the first index E1 may indicate a case where the address is smaller than a value calculated by subtracting the delta boundary value from the reference address, and the second index E2 may indicate a case where the address is larger than a value calculated by adding the delta boundary value to the reference address. Alternatively, the first index E1 may indicate a case where the size of a delta exceeds the delta boundary value and the delta has a negative sign, and the second index E2 may indicate a case where the size of a delta exceeds the delta boundary value and the delta has a positive sign.

For example, the first frequency N1 may indicate the number of first flags within the label window, and the second frequency N2 may indicate the number of second flags within the label window. The first frequency N1 may indicate the number of deltas (or addresses) corresponding to the first index E1 within the label window, and the second frequency N2 may indicate the number of deltas (or addresses) corresponding to the second index E2 within the label window.

For example, since the weight corresponding to the fifth time point t5 within the label window is the first flag, and the weight corresponding to the eighth time point t8 is the first flag, the first frequency N1 may be ‘2’. That is, the computing system 1000 may set the number of first flags within the label window to the first frequency N1. For example, since a corresponding weight at the sixth time point t6 within the label window is the second flag, the second frequency N2 may be ‘1’. That is, the computing system 1000 may set the number of second flags within the label window to the second frequency N2.

In embodiments, the proximity delta set NDS may include weights corresponding to proximate position indices. In embodiments, the proximate position index may include first to sixth proximate position indices P1 to P6. For example, the first proximate position index P1 may indicate a delta having a value of ‘−3’, the second proximate position index P2 may indicate a delta having a value of ‘−2’, the third proximate position index P3 may indicate a delta having a value of ‘−1’, the fourth proximate position index P4 may indicate a delta having a value of ‘+1’, the fifth proximate position index P5 may indicate a delta having a value of ‘+2’, and the sixth proximate position index P6 may indicate a delta having a value of ‘+3’.

The proximity delta set NDS may include a first weight V1 corresponding to the first proximate position index P1, a second weight V2 corresponding to the second proximate position index P2, a third weight V3 corresponding to the third proximate position index P3, a fourth weight V4 corresponding to the fourth proximate position index P4, a fifth weight V5 corresponding to the fifth proximate position index P5, and a sixth weight V6 corresponding to the sixth proximate position index P6.

The computing system 1000 may generate the position delta map PDM by considering redundancy into account. The computing system 1000 may generate the position delta map PDM by summing up the weights of identical deltas within the label window.

For example, the first weight V1 may be a value obtained by summing up weights of deltas corresponding to the first proximate position index P1 in the label window. The second weight V2 may be a value obtained by summing up weights of deltas corresponding to the second proximate position index P2 in the label window. The third weight V3 may be a value obtained by summing up weights of deltas corresponding to the third proximate position index P3 in the label window. The fourth weight V4 may be a value obtained by summing up weights of deltas corresponding to the fourth proximate position index P4 in the label window. The fifth weight V5 may be a value obtained by summing up weights of deltas corresponding to the fifth proximate position index P5 in the label window. The sixth weight V6 may be a value obtained by summing up weights of deltas corresponding to the sixth proximate position index P6 in the label window.

For example, the third delta corresponding to the fourth time point t4 is ‘−3’, and since the third delta corresponds to the first proximate position index P1, the first weight V1 may be a weight corresponding to the fourth time point t4. The first weight V1 may be ‘6’. Within the label window, the second weight V2 may be ‘0’ since there is no delta corresponding to the second proximate position index P2. The first delta corresponding to the second time point t2 is ‘−1’, and since the first delta corresponds to the third proximate position index P3, the third weight V3 may be ‘8’. The second delta corresponding to the third time point t3 is ‘+1’, and the second delta corresponds to the fourth proximate position index P4, and the sixth delta corresponding to the seventh time point t7 is ‘+1’, and the sixth delta corresponds to the fourth proximate position index P4, and thus the fourth weight V4 may be ‘10’. The fourth weight V4 may be a value that is a value obtained by summing up the weight corresponding to the third time point t3 and the weight corresponding to the seventh time point t7. The eighth delta corresponding to the ninth time point t9 is ‘+2’, and since the eighth delta corresponds to the fifth proximate position index P5, the seventh weight V7 may be ‘1’. Within the label window, the eighth weight V8 may be ‘0’ because there is no delta corresponding to the sixth proximate position index P6.

In embodiments, the computing system 1000 may divide the first and second frequencies N1, N2 by the length of the label window (e.g., ‘8’). The first and second frequencies N1 and N2 may be normalized by the length of the label window. Accordingly, the neural network model 1130 may identify the relative frequency of escape deltas within the label window.

In embodiments, the computing system 1000 may divide the first through sixth weights V1 to V6 by the maximum value of the weight (e.g., 10). Accordingly, the first to sixth weights V1 to V6 may be normalized between 0 and 1. Accordingly, the neural network model 1130 may assign priority to deltas according to the relative importance thereof within the label window. Accordingly, the neural network model 1130 may predict a prefetch address accurately. The neural network model 1130 may be trained with respect to relative importance based on the temporal proximity and redundancy (or frequency of occurrence) of deltas through the position delta map PDM.

As described above, the computing system 1000 may generate the position delta map PDM by considering both temporal proximity and redundancy. Accordingly, the accuracy of a prefetch address prediction operation may be improved.

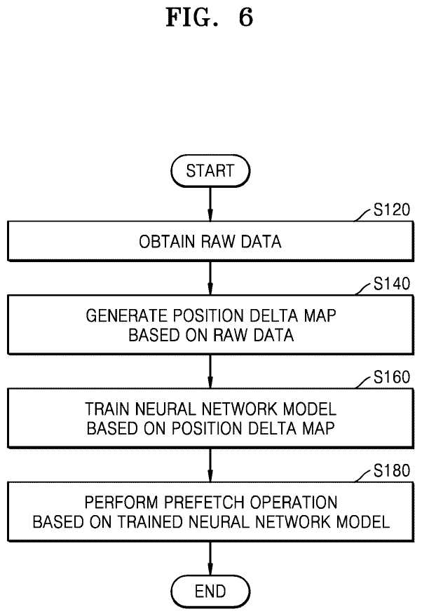

FIG. 6 is a flowchart showing an example of a method of operating the computing system of FIG. 1, according to embodiments.

Referring to FIGS. 1 and 6, the computing system 1000 may train a neural network model. The computing system 1000 may predict a prefetch address by using the trained neural network model.

In operation S120, the computing system 1000 may obtain raw data. For example, raw data may include time series data that includes memory access history information. The raw data may be used to generate training data, labels, or the position delta map PDM for training neural networks.

In operation S140, the computing system 1000 may generate the position delta map PDM based on the raw data. The position delta map PDM may be generated by considering temporal proximity and redundancy with the reference address. The position delta map PDM may be a label to improve the prediction accuracy of prefetch addresses. The computing system 1000 may generate the position delta map PDM used as training data or a label for a neural network model, based on the raw data. Alternatively, the computing system 1000 may obtain the position delta map PDM from an external server over a network.

In operation S160, the computing system 1000 may train a neural network model based on the position delta map PDM. The neural network model may be implemented as a binary temporal convolutional neural network or a variant thereof. The computing system 1000 may store the trained neural network model in the memory device 1400. The neural network model may be initialized with trained weights.

In operation S180, the computing system 1000 may perform a prefetch operation based on the trained neural network model. The computing system 1000 may output input data, which is a result of performing an XOR operation on an address and an inverted program counter, into the trained neural network model 1130. The computing system 1000 may predict prefetch addresses that are likely to be accessed. The computing system 1000 may load data from the memory device 1400 into the cache memory 1300 based on a predicted prefetch address. Accordingly, a computing system with improved performance may be provided.

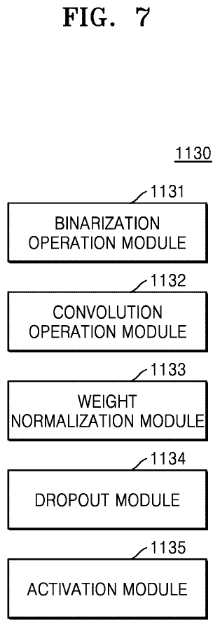

FIG. 7 is a block diagram illustrating a neural network model of FIG. 1 in detail according to embodiments.

Referring to FIGS. 1 and 7, the neural network model 1130 may include a binarization operation module 1131, a convolution operation module 1132, a weight normalization module 1133, a dropout module 1134, and an activation module 1135. The neural network model 1130 may receive the input data ID, which is a result of performing an XOR operation on the address ADDR and the inverted program counter INV_PC. The neural network model 1130 may output a prediction delta for a reference address as output data.

The computing system 1000 may perform a prefetch address prediction operation using the neural network model 1130. The neural network model 1130 may be an artificial intelligence model trained using the position delta map PDM. The neural network model 1130 may be a binary temporal convolutional neural network model. The binary temporal convolutional neural network model may be trained based on the position delta map PDM.

A neural network is implemented by including a plurality of layers, and each layer performs operations based on inputs and weights to generate outputs. The binary temporal convolutional neural network is a convolutional neural network specialized for processing time series data, where weights are expressed as single bits, and thus the amount of computation and memory required may be reduced. Hereinafter, embodiments are described based on a case where the neural network model 1130 is a binary temporal convolutional neural network model.

The neural network model 1130 may perform neural network operations. A neural network operation may include a series of operations of inputting data into a neural network and obtaining output data. For example, a neural network operation may include, but is not limited to, element-wise multiplication operations for convolution operations, cumulative sum operations, etc. For example, the binary temporal convolutional neural network model may receive input data, perform a neural network operation based on the input data, and output a prediction delta.

Since the input data ID is binary data, a binarization operation may not be applied. The output values output from the dropout module 1134 may be transmitted to the binarization operation module 1131. The binarization operation module 1131 may perform a binarization operation on an output value of a previous loop. The binarization operation module 1131 may perform a binarization operation based on Equation 1. x may represent an output value of a previous layer, and a may represent a trainable channel-specific threshold.

$$RSig n ( x ) = \{ \begin{matrix}+ 1 , & if x > α \\ - 1 , & if x \leq α\end{matrix} \qquad [ Equation 1 ]$$

The convolution operation module 1132 may perform a binary dilated causal convolution operation on a result value of the binarization operation module 1131 or the input data ID. For example, the convolution operation module 1132 may perform a binary dilated causal convolution operation of input data and weights. The convolution operation module 1132 may perform a binary dilated causal convolution operation based on Equation 2. Here, W_{B} may represent a binary weight, and W_{R} may represent a real weight, and ∥W_{R}∥ₗ₁ may represent the L1 norm of the real weight, and α may represent a threshold per trainable channel, and n_{W} may represent the number of elements of the weight.

$${W}_{B} = \frac{{‖ {W}_{R} ‖}_{l 1}}{{n}_{W}} RSign ( {W}_{R} ) = \{ \begin{matrix}+ \frac{{‖ {W}_{R} ‖}_{l 1}}{{n}_{W}} , & if {W}_{R} > α \\ - \frac{{‖ {W}_{R} ‖}_{l 1}}{{n}_{W}} , & if {W}_{R} \leq α\end{matrix} \qquad [ Equation 2 ]$$

The weight normalization module 1133 may receive a result of the convolution operation module 1132. The weight normalization module 1133 may perform a weight normalization operation on the result of the convolution operation module 1132. The weight normalization module 1133 may perform a weight normalization operation based on Equation 3. Here, W may represent a weight, and g may represent a size of the weight, and V may represent a direction of the weight, and ∥V∥ₗ₂ may represent the L2 norm in the weight direction.

$$W = g \frac{V}{{‖ V ‖}_{l 2}} \qquad [ Equation 3 ]$$

The dropout module 1134 may probabilistically disable some neurons during learning. For example, the dropout module 1134 may temporarily remove output of some neurons or feature maps with a certain probability (e.g., 0.5) at each learning iteration or loop.

The activation module 1135 may apply an activation function to a result output from the dropout module 1134 to output output data. For example, the activation module 1135 may perform an activation operation based on Equation 4. x may represent an output value of a previous layer, and γ may represent a trainable channel-wise parallel movement, and ζ may represent a trainable channel-wise parallel movement, and β may represent a trainable channel-specific gradient. For example, an activation operation may refer to an operation of applying an activation function to an input of the activation module 1135. However, the scope of the inventive concept is not limited thereto, and the activation function may include RELU, sigmoid, tanh, etc.

$$RPReLU ( x ) = \{ \begin{matrix}x - γ + ζ , & if x > γ \\ β ( x - γ ) + ζ , & if x \leq γ\end{matrix} \qquad [ Equation 4 ]$$

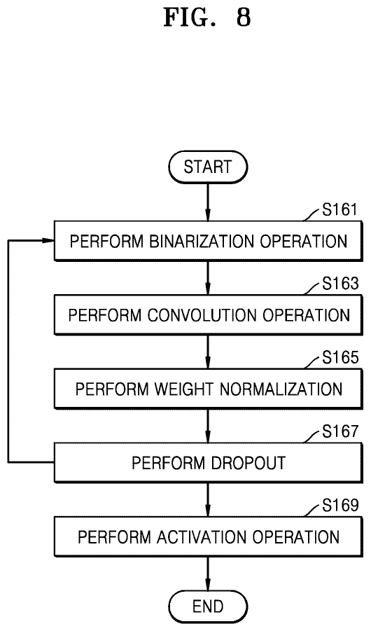

FIG. 8 is a flowchart showing an example of a method of operating the computing system of FIG. 1, according to embodiments.

Referring to FIG. 8, a learning process of the neural network model 1130 is described. Referring to FIGS. 7 and 8, the computing system 1000 may training the neural network model 1130. Operation S160 of FIG. 6 may include operations S161 to S169. In operation S161, the computing system 1000 may perform a binarization operation. The binarization operation module 1131 may perform a binarization operation on the result value of the dropout module 1134. Since the input data is binary data, a binarization operation may not be performed.

In operation S163, the computing system 1000 may perform a convolution operation. The convolution operation module 1132 may perform a binary dilated causal convolution operation. For example, the convolution operation module 1132 may perform element-wise multiplication of input data and weights and add up results of the element-wise multiplication.

In operation S165, the computing system 1000 may perform a weight normalization operation. The weight normalization module 1133 may perform a weight normalization operation. In operation S167, the computing system 1000 may drop out some neurons. The dropout module 1134 may disable specific neurons.

After operation S167, the computing system 1000 may perform operation S161 again. The sequential performance of operations S161 to S167 may be defined as one iteration or loop, and the neural network model 1130 may be trained by performing the iteration multiple times. As the iteration is performed, the weights of the neural network model may be updated.

In operation S169, the computing system 1000 may perform an activation operation. For example, the activation module 1135 may generate output data by applying an activation function. The computing system 1000 may initialize the neural network model 1130 by using the trained weights. The computing system 1000 may store the trained neural network model 1130 in the memory device 1400. The computing system 1000 may store the neural network model 1130 that is initialized with the trained weights, in the memory device 1400.

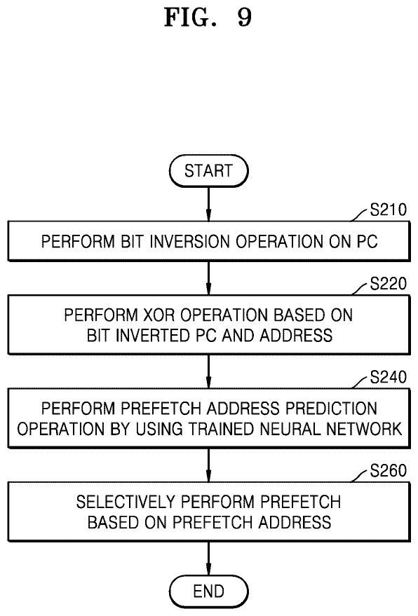

FIG. 9 is a flowchart showing an example of a method of operating the computing system of FIG. 1, according to embodiments.

Referring to FIGS. 1, 6, and 9, the computing system 1000 may perform a prefetch operation based on a binary temporal convolutional neural network. The computing system 1000 may perform a prefetch address prediction operation based on the trained neural network model 1130.

The computing system 1000 may obtain the trained neural network model 1130. In operation S210, the computing system 1000 may perform a bit inversion operation on the program counter PC. The prefetch engine 1100 may generate the inverted program counter INV_PC by reversing the bit sequence of the program counter PC.

In operation S220, the computing system 1000 may perform an XOR operation based on the inverted program counter INV_PC and the address ADDR. The prefetch engine 1100 may generate the input data ID by performing an XOR operation on the inverted program counter INV_PC and the address ADDR.

In operation S240, the computing system 1000 may perform a prefetch address prediction operation by using the trained neural network model 1130. The prefetch engine 1100 may output the input data ID into the trained neural network model 1130 to generate output data, which is a prediction delta. The prefetch engine 1100 may optionally generate a prefetch address.

In operation S260, the computing system 1000 may selectively perform data prefetch based on the prefetch address. The prefetch engine 1100 may transmit a prefetch address to the cache manager. Data corresponding to the prefetch address and stored in the memory device 1400 may be prefetched or loaded into the cache memory 1300.

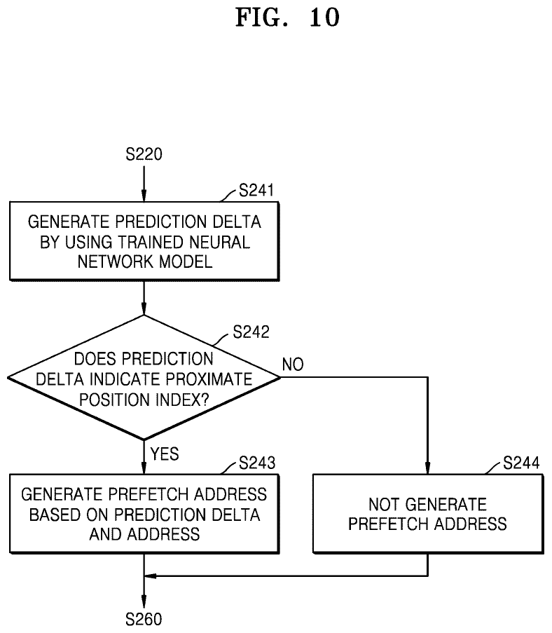

FIG. 10 is a flowchart showing operation S240 of FIG. 9 in detail according to embodiments.

Referring to FIGS. 1, 9, and 10, the computing system 1000 may perform a prefetch address prediction operation by using a trained binary-temporal convolutional neural network model. Operation S240 of FIG. 9 may include operations S241 to S244. In operation S241, the computing system 1000 may generate a prediction delta by using the trained neural network model 1130. The prefetch engine 1100 may output input data into the trained binary temporal convolutional neural network model to generate output data, which is a prediction delta. The trained binary-temporal convolutional neural network model may output a prediction delta. The prediction delta may indicate an escape index or a proximate position index.

In operation S242, the computing system 1000 may determine whether the prediction delta indicates a proximate position index. The computing system 1000 may perform operation S243 if the prediction delta indicates the proximate position index, and may perform operation S244 if the prediction delta does not indicate the proximate position index (i.e., if the prediction delta indicates an escape index).

In operation S243, the computing system 1000 may generate a prefetch address based on the prediction delta and the address. The prefetch engine 1100 may generate a prefetch address by adding the prediction delta and the address when the prediction delta indicates the proximate position index.

In operation S244, the computing system 1000 may not generate a prefetch address. The prefetch engine 1100 may not generate a prefetch address if the prediction delta indicates an escape index. Accordingly, the computing system 1000 may skip a prefetch operation.

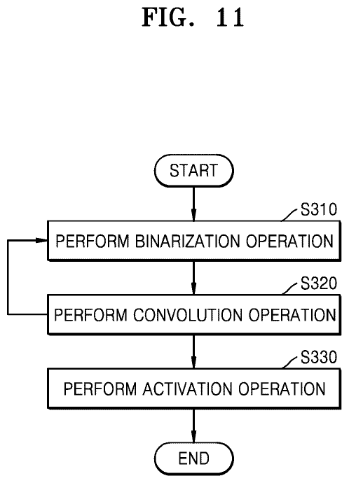

FIG. 11 is a flowchart showing operation S241 of FIG. 10 in detail according to embodiments.

Referring to FIG. 11, an inference process of the neural network model 1130 is described. Referring to FIGS. 10 and 11, the computing system 1000 may generate a prediction delta by using a binary temporal convolutional neural network model. The neural network model 1130 may receive input data and output a prediction delta. Operation S241 of FIG. 10 may include operations S310 to S330.

During a learning process of a neural network model, the values of the weights are adjusted, but after the training of the neural network model is completed, the values of the weights have static values. Before the computing system 1000 performs a prefetch operation using a neural network model for which training has been completed, the neural network model may be initialized using the trained weights.

In embodiments, the computing system 1000 may obtain the neural network model 1130, training of which has been completed. The neural network model 1130 may be received from an external device (e.g., a server, etc.) through a communication interface of the computing system 1000 or may be stored in a memory of the computing system 1000.

The computing system 1000 may perform inference on input data by using the neural network model 1130. In operation S310, the computing system 1000 may perform a binarization operation. For example, the binarization operation module 1131 may perform a binarization operation on a result value of the convolution operation module 1132. Since the input data is binary data, a binarization operation may not be performed.

In operation S320, a convolution operation may be performed. The convolution operation module 1132 may perform a binary dilated causal convolution operation. For example, the convolution operation module 1132 may perform element-wise multiplication of input data and weights and add up the results of the element-wise multiplication.

After operation S320, the computing system 1000 may perform operation S310 again. The sequential performance of operations S310 and S320 may be defined as one iteration or loop, and by performing the iteration multiple times, the neural network model may output an inference result.

In operation S330, the computing system 1000 may perform an activation operation. For example, the activation module 1135 may generate output data by applying an activation function. The trained neural network model 1130 may output a prediction delta.

Compared to the learning process of the neural network model 1130 of FIG. 8, the inference process of the neural network model 1130 may not include a weight normalization operation and a dropout operation. Since the inference process generates a prediction delta by using the neural network model 1130 that is initialized with trained weights, the computing system 1000 may not perform a weight normalization operation or dropout during the inference process. By storing the weights in a form that reflects the trained threshold value and weight normalization parameters calculated in advance, efficient processing may be achieved without additional storage overhead or computational complexity during the inference process.

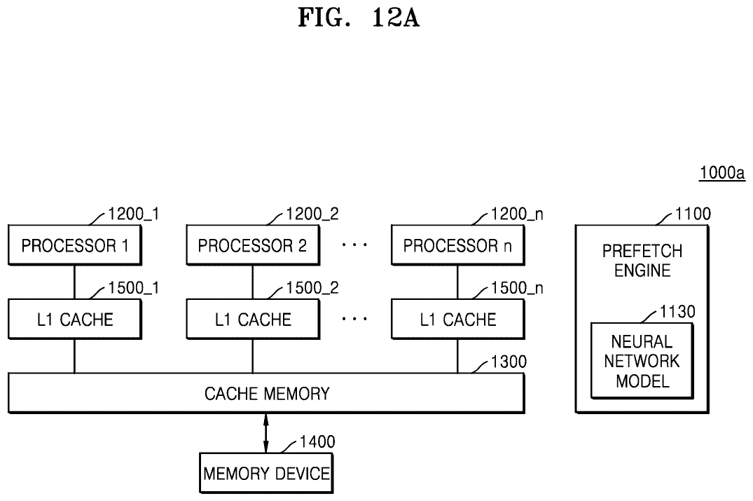

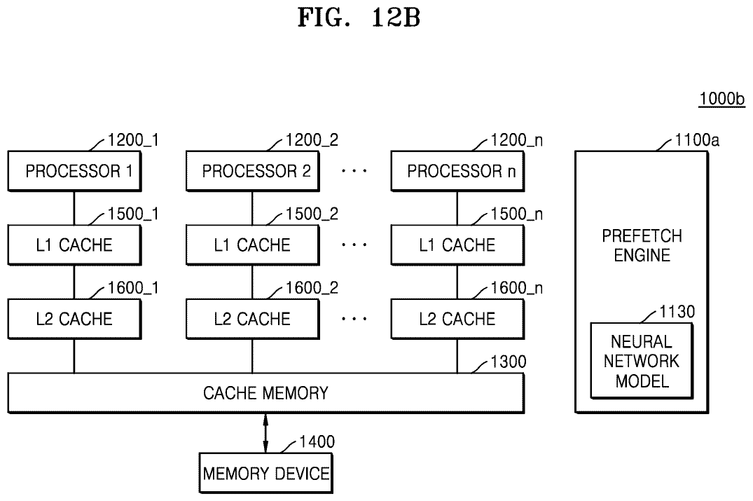

FIGS. 12A and 12B are block diagrams illustrating a computing system according to embodiments.

Referring to FIGS. 1 and 12A, a computing system 1000a may include the prefetch engine 1100, first to n-th processors 1200_1 to 1200_n, the cache memory 1300, a memory device, and first to n-th L1 caches 1500_1 to 1500_n. The prefetch engine 1100 may include the neural network model 1130. For convenience of description, detailed descriptions of the components described above are omitted.

In embodiments, the computing system 1000a may include a multi-core processor. The first to n-th L1 caches 1500_1 to 1500_n may store a portion of data stored in the memory device 1400. The first to n-th L1 caches 1500_1 to 1500_n may be implemented as volatile memory (e.g., SRAM), but the inventive concept is not limited thereto.

Each of the first to n-th L1 caches 1500_1 to 1500_n and the cache memory 1300 may be hierarchically connected to each other. Each of the first to n-th L1 caches 1500_1 to 1500_n and the cache memory 1300 may be connected in series between the corresponding processor and the memory device 1400. Each of the first to n-th L1 caches 1500_1 to 1500_n may provide a cache function to the corresponding processor. For example, the first L1 cache 1500_1 may provide cache functionality to the first processor 1200_1. For example, the first L1 cache 1500_1 may correspond to the first processor 1200_1, and a second L1 cache 1500_2 may correspond to a second processor 1200_2. The remaining L1 caches are similar, so detailed descriptions are omitted.

Each of the first to n-th L1 caches 1500_1 to 1500_n may be connected between a corresponding processor and the cache memory 1300. Each of the first to n-th L1 caches 1500_1 to 1500_n may be connected to the memory device 1400 through the cache memory 1300. Each of the first to n-th L1 caches 1500_1 to 1500_n may be directly connected to their respective corresponding processor. Each of the first to n-th L1 caches 1500_1 to 1500_n may be a top-level cache.

The cache memory 1300 may be connected between each of the first to n-th L1 caches 1500_1 to 1500_n and the memory device 1400. The cache memory 1300 may be connected to the first to n-th processors 1200_1 to 1200_n through the first to n-th L1 caches 1500_1 to 1500_n, respectively. The cache memory 1300 may be a lowest level cache directly connected to the memory device 1400. The first to n-th processors 1200_1 to 1200_n may share the cache memory 1300.

Referring to FIGS. 1 and 12B, the computing system 1000a may include the prefetch engine 1100, the first to n-th processors 1200_1 to 1200_n, the cache memory 1300, a memory device, the first to n-th L1 caches 1500_1 to 1500_n, and first to n-th L2 caches 1600_1 to 1600_n. The prefetch engine 1100 may include the neural network model 1130. For convenience of description, detailed descriptions of the components described above are omitted.

In embodiments, the computing system 1000a may include a multi-core processor. The first to n-th L1 caches 1500_1 to 1500_n may store a portion of data stored in the memory device 1400. The first to n-th L1 caches 1500_1 to 1500_n may be implemented as volatile memory (e.g., SRAM), but the inventive concept is not limited thereto. The first to n-th L2 caches 1600_1 to 1600_n may store a portion of data stored in the memory device 1400. The first to n-th L2 caches 1600_1 to 1600_n may be implemented as volatile memory (e.g., SRAM), but the inventive concept is not limited thereto.

The first to n-th L1 caches 1500_1 to 1500_n, the first to n-th L2 caches 1600_1 to 1600_n, and the cache memory 1300 may be hierarchically connected to each other. The first to n-th L1 caches 1500_1 to 1500_n, the first to n-th L2 caches 1600_1 to 1600_n, and the cache memory 1300 may be connected in series between a corresponding processor and the memory device 1400. Each of the first to n-th L1 caches 1500_1 to 1500_n may provide a cache function to the corresponding processor. For example, the first L1 cache 1500_1 may provide cache functionality to the first processor 1200_1. Each of the first to n-th L2 caches 1600_1 to 1600_n may provide a cache function to the corresponding processor. For example, the first L2 cache 1600_1 may provide cache functionality to the first processor 1200_1.

Each of the first to n-th L1 caches 1500_1 to 1500_n may be connected between the corresponding processor and a corresponding L2 cache. Each of the first to n-th L1 caches 1500_1 to 1500_n may be connected to the memory device 1400 through a corresponding L2 cache and the cache memory 1300. Each of the first to n-th L1 caches 1500_1 to 1500_n may be directly connected to a corresponding processor. Each of the first to n-th L1 caches 1500_1 to 1500_n may be a top-level cache.

Each of the first to n-th L2 caches 1600_1 to 1600_n may be connected between a corresponding L1 cache and the cache memory 1300. Each of the first to n-th L2 caches 1600_1 to 1600_n may be connected to the memory device 1400 through the cache memory 1300 which the first to n-th L2 caches 1600_1 to 1600_n correspond to. Each of the first to n-th L2 caches 1600_1 to 1600_n may be connected to a corresponding processor through a corresponding L1 cache. Each of the first to n-th L2 caches 1600_1 to 1600_n may be a second-level cache.

The cache memory 1300 may be connected between each of the first to n-th L2 caches 1600_1 to 1600_n and the memory device 1400. The cache memory 1300 may be connected to the first to n-th processors 1200_1 to 1200_n through the first to n-th L1 caches 1500_1 to 1500_n, respectively, and the first to n-th L2 caches 1600_1 to 1600_n, respectively. The cache memory 1300 may be a lowest level cache directly connected to the memory device 1400. The first to n-th processors 1200_1 to 1200_n may share the cache memory 1300.

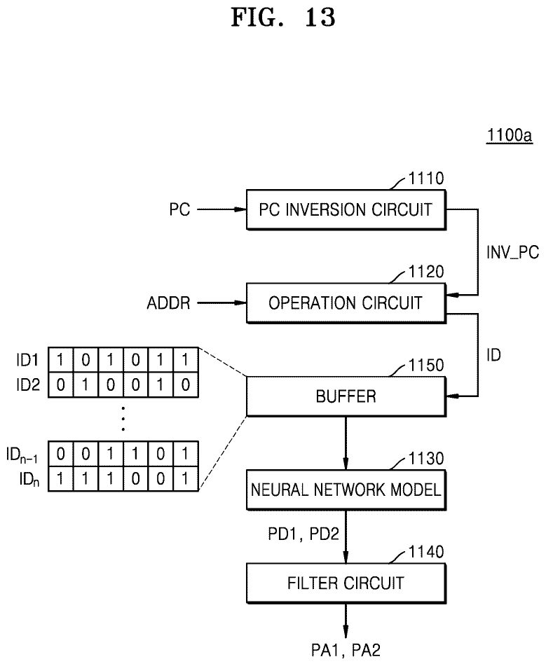

FIG. 13 is a block diagram illustrating the prefetch engine of FIG. 1 in detail according to embodiments.

Referring to FIGS. 2 and 13, the prefetch engine 1100 may include the PC inversion circuit 1110, the operation circuit 1120, the neural network model 1130, the filter circuit 1140, and a buffer 1150. It is assumed that a program counter set includes first to n-th program counters PC1 to PCn, an address set includes first to n-th addresses ADDR1 to ADDRn, an inverted program counter set includes first to n-th inverted program counters INV_PC1 to INV_PCn, and an input data set includes first to n-th input data ID1 to IDn. Here, n is a natural number.

For example, an i-th program counter PCi may indicate a program counter at an i-th time point. An i-th address ADDRi may indicate an address at the i-th time point. An i-th inverted program counter INV_PCi may indicate an inverted program counter generated by performing a bit inversion operation on the i-th program counter PCi. i-th input data IDi may indicate input data generated based on the i-th program counter PCi and the i-th address ADDRi. The i-th input data IDi may indicate a result value of performing an XOR operation on the i-th inverted program counter INV_PCi and the i-th address ADDRi. Here, i is a natural number, and i may be less than or equal to n.

The operation circuit 1120 may receive the i-th inverted program counter INV_PCi and the i-th address ADDRi. The operation circuit 1120 may perform an XOR operation on the i-th inverted program counter INV_PCi and the i-th address ADDRi to generate the i-th input data IDi. The operation circuit 1120 may store the i-th input data IDi in the buffer 1150.

The operation circuit 1120 may store the first to n-th input data ID1 to IDn in the buffer 1150. For example, the operation circuit 1120 may store the first input data ID1 in the buffer 1150 and the second input data ID2 in the buffer 1150. The remaining input data ID3 to IDn are identical to the above, and thus detailed descriptions are omitted.

An input data set (or a plurality of pieces of input data) stored in the buffer 1150 may be input to the neural network model 1130. The plurality of pieces of input data ID1 to IDn may be stored in the buffer 1150. In embodiments, the buffer 1150 may be configured in a First-In First-Out (FIFO) structure. In the buffer 1150, input data that is stored first may be removed first according to the insertion order of the input data. The neural network model 1130 may receive the first to n-th input data ID1 to IDn stored in the buffer 1150. The neural network model 1130 may output output data for the first to n-th input data ID1 to IDn.

In embodiments, the neural network model 1130 may output a plurality of prediction deltas. The neural network model 1130 may output a first prediction delta PD1 and a second prediction delta PD2. The neural network model 1130 may generate two prediction deltas with high accessibility.

The filter circuit 1140 may receive the first prediction delta PD1 and the second prediction delta PD2. Both the first prediction delta PD1 and the second prediction delta PD2 may indicate a proximate position index. The filter circuit 1140 may generate a first prefetch address PA1 based on the reference address and the first prediction delta PD1. The reference address may be an address corresponding to the first prediction delta PD1. The reference address may be an address used to generate input data corresponding to the first prediction delta PD1. The filter circuit 1140 may generate the first prefetch address PA1 by adding the reference address and the first prediction delta PD1. The filter circuit 1140 may generate a second prefetch address PA2 based on the reference address and the second prediction delta PD2. The filter circuit 1140 may generate the second prefetch address PA2 by adding the reference address and the second prediction delta PD2.

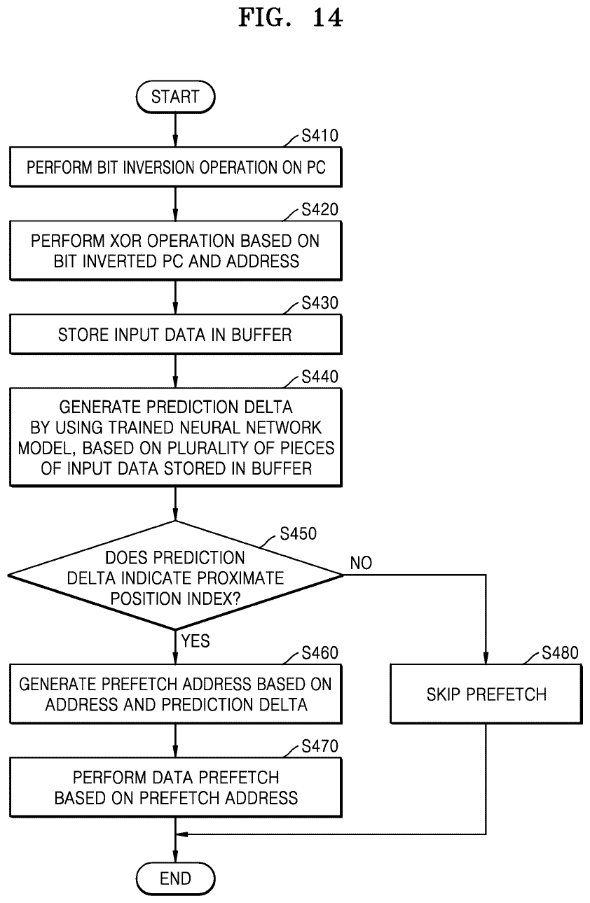

FIG. 14 is a flowchart showing an example of a method of operating a computing system, according to embodiments.

Referring to FIGS. 1 and 14, the computing system 1000 may perform a prefetch operation based on a binary temporal convolutional neural network model. In operation S410, the computing system 1000 may perform a bit inversion operation on the program counter PC. The prefetch engine 1100 may generate the inverted program counter INV_PC by reversing the bit string of the program counter PC.

In operation S420, the computing system 1000 may perform an XOR operation based on the inverted program counter INV_PC and the address ADDR. The prefetch engine 1100 may generate the input data ID by performing an XOR operation on the inverted program counter INV_PC and the address ADDR.

In operation S430, the computing system 1000 may store the input data ID in the buffer 1150. In operation S440, the computing system 1000 may generate a prediction delta by using the trained neural network model 1130 based on a plurality of pieces of input data stored in the buffer 1150. The prefetch engine 1100 may output the plurality of pieces of input data into the trained binary temporal convolutional neural network model to generate output data, which is a prediction delta.

In operation S450, the computing system 1000 may determine whether the prediction delta indicates a proximate position index. If the prediction delta indicates a proximate position index, the computing system 1000 may perform operation S460, and if the prediction delta does not indicate a proximate position index, the computing system 1000 may perform operation S480.

In operation S460, the computing system 1000 may generate a prefetch address based on the address and the prediction delta. The prefetch engine 1100 may generate a prefetch address by adding the prediction delta to the address if the prediction delta indicates a proximate position index.

In operation S470, the computing system 1000 may perform data prefetch based on the prefetch address. The computing system 1000 may load data corresponding to the prefetch address from the memory device 1400 to the cache memory 1300.

In operation S480, the computing system 1000 may skip data prefetch. The prefetch engine 1100 may skip data prefetch without generating a prefetch address if the prediction delta indicates an escape index.

The prefetch address prediction operation according to embodiments of the inventive concept may be represented as shown in [Table 1] below.

TABLE 1
Algorithm 1 BTCP inference

Require: BTCP with trained weights W_{B}, BTCP input X, global history buffer G H B, prefetch degree P D, block

address a, PC pc

Ensure: Prefetching addresses at time t

| | | |
|---|---|---|
| 1: | for [symbol] ← 0 to T − l do | |
| 2: | o [symbol] ← hash(aᵢ) | [symbol] Hash block address to ensure n-bit length |
| 3: | pcₛ ← bit-reverese(hash(pc [symbol] )) | [symbol] Hash and bit-reverse PC to ensure n-bit length |
| 4: | x [symbol] ← XOR(aₛ, pcₛ) | [symbol] Perform XOR operations between the address and bit-reveresed PC |
| 5: | Push x [symbol] to G H B for X [symbol] | |
| 6: | Ŷₜ ← BTCP(X [symbol] ;W_{B}) | [symbol] Perform BTCP interence using input X [symbol] and weights W_{B} |
| 7: | pref _cand ← argso [symbol] (Ŷ [symbol] \|−P D : [symbol] | [symbol] Determine prefetching candidates pref _cand based on prediction |

| | |
|---|---|
| 8: | for pd ← 0 to P D − l do |
| 9: | if pref _cand[pd] = êₚ or pref _cand[pd] êₙ then |
| 10: | Do not perform prefetching |
| 11: | else |
| 12: | Calculate predicted address using a [symbol] and pref _cand[pd] |
| 13: | Prefetch predicted address |
| 14: | end if |
| 15: | end for |
| 16: | end for |

[symbol]

indicates data missing or illegible when filed

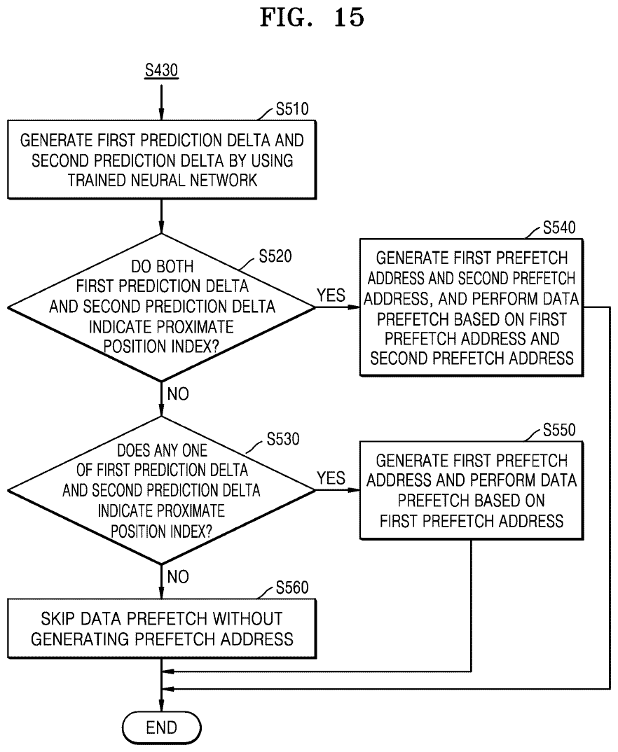

FIG. 15 is a flowchart showing an example of a method of operating a computing system, according to embodiments.

Referring to FIGS. 1, 14, and 15, in embodiments, the trained neural network model 1130 may output a plurality of prediction deltas. After operation S430 of FIG. 14, the computing system 1000 may perform operations S510 to S560.

In operation S510, the computing system 1000 may generate a first prediction delta and a second prediction delta by using the trained neural network model 1130. A binary temporal convolutional neural network model may output a first prediction delta and a second prediction delta.

In operation S520, the computing system 1000 may determine whether both the first prediction delta and the second prediction delta indicate a proximate position index. The computing system 1000 may perform operation S540 if both the first prediction delta and the second prediction delta indicate a proximate position index. The computing system 1000 may perform operation S530 if both the first prediction delta and the second prediction delta do not indicate a proximate position index.

In operation S530, the computing system 1000 may determine whether any one of the first prediction delta and the second prediction delta indicates a proximate position index. The computing system 1000 may perform operation S550 if either the first prediction delta or the second prediction delta indicates a proximate position index. The computing system 1000 may perform operation S560 if either of the first prediction delta and the second prediction delta does not indicate a proximate position index.

In operation S540, the computing system 1000 may generate a first prefetch address and a second prefetch address, and perform data prefetch based on the first prefetch address and the second prefetch address. Since the first prediction delta indicates a proximate position index, the prefetch engine 1100 may generate a first prefetch address based on the first prediction delta and the reference address. Since the second prediction delta indicates a proximate position index, the prefetch engine 1100 may generate a second prefetch address based on the second prediction delta and the reference address.

In operation S550, the computing system 1000 may generate the first prefetch address and perform data prefetch based on the first prefetch address. Since either the first prediction delta or the second prediction delta indicates a proximate position index, the first prefetch address may be generated based on a prediction delta indicating a proximate position index and the reference address.

In operation S560, the computing system 1000 may skip data prefetch without generating a prefetch address. The computing system 1000 may not generate a prefetch address as both the first prediction delta and the second prediction delta indicate an escape index.

As described above, the trained neural network model 1130 may output an escape index or a proximate position index. The prefetch engine 1100 may skip a prefetch operation if the prediction delta indicates an escape index. The prefetch engine 1100 may generate a prefetch address if the prediction delta indicates a proximate position index. That is, the prefetch engine 1100 may optionally perform a prefetch operation. By performing an adaptive prefetch operation, the risk of cache contamination may be alleviated and performance may be improved.

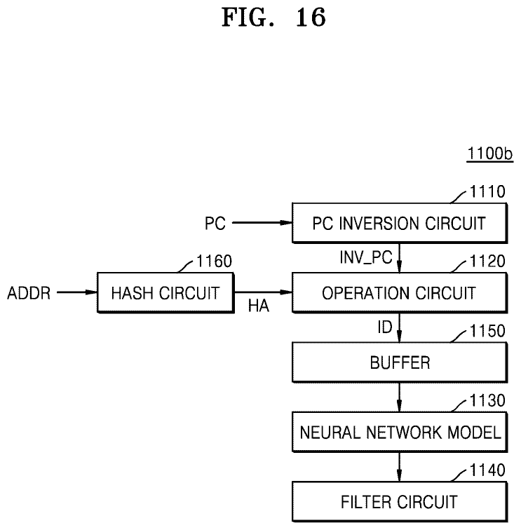

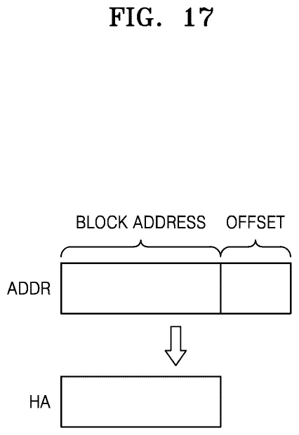

FIG. 16 is a block diagram illustrating the prefetch engine of FIG. 1 in detail according to embodiments. FIG. 17 is a diagram for describing a hash address according to embodiments.

Referring to FIGS. 16 and 17, the prefetch engine 1100 may include the PC inversion circuit 1110, the operation circuit 1120, the neural network model 1130, the filter circuit 1140, the buffer 1150, and a hash circuit 1160.

The computing system 1000 may perform a prefetch operation in units of a cache line. For example, a cache line may be a minimum access unit of data loaded from the memory device 1400 to the cache memory 1300. The size of a cache line may be, for example, 32 bytes or 64 bytes. This is an example and the scope of the inventive concept is not limited thereto.

The hash circuit 1160 may receive an address ADDR. The hash circuit 1160 may perform a hash operation on the address ADDR to generate a hash address HA. For example, the hash circuit 1160 may perform a hash operation on the address ADDR to generate the hash address HA. The hash circuit 1160 may calculate a hash value for the address ADDR. The hash circuit 1160 may perform a hash operation on the address ADDR and output a hash value corresponding to the address ADDR. The hash value may be the hash address HA. The hash circuit 1160 may provide the hash address HA to the operation circuit 1120.

The operation circuit 1120 may receive the hash address HA and the inverted program counter INV_PC. The operation circuit 1120 may generate the input data ID by performing an XOR operation on the hash address HA and the inverted program counter INV_PC. The operation circuit 1120 may provide the input data ID to the buffer 1150.

In embodiments, the address ADDR may include a physical address. The address ADDR may refer to address information used to access data stored in the memory device 1400. For example, the address ADDR may include 64 bits. For example, a physical address may be used to access storage space of the memory device 1400 in units of bytes.

In embodiments, the address ADDR may include a block address and an offset. The offset may indicate lower bits corresponding to units of cache lines. For example, if a unit of cache lines (or size) is 64 bytes, the offset may consist of lower 6 bits. The offset may indicate ADDR [5:0] among the 64 bits of the address ADDR.

A block address may be used to access the storage space of the memory device 1400 in units of cache lines. A block address may indicate address information consisting of higher bits excluding an offset from a physical address to identify data in units of cache lines. For example, a block address may consist of 58 bits. A block address may indicate ADDR [63:6] among the 64 bits of the address ADDR.

In embodiments, the hash circuit 1160 may generate the hash address HA based on the address ADDR. The hash circuit 1160 may remove an offset from the address ADDR and convert the same into the hash address HA corresponding to a block address. The hash address HA may be a block address.

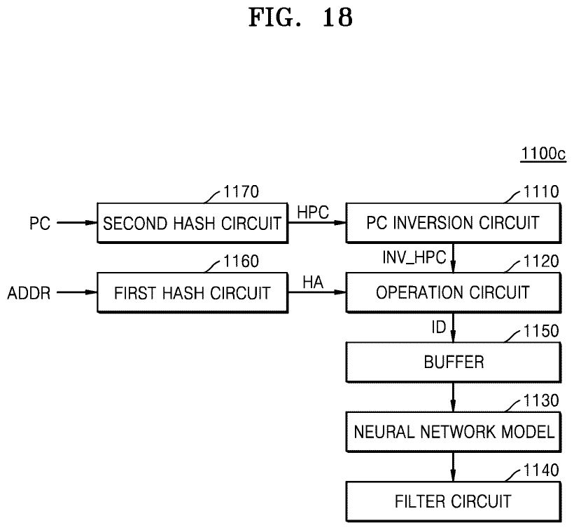

FIG. 18 is a block diagram illustrating the prefetch engine of FIG. 1 in detail according to embodiments.

Referring to FIG. 18, the prefetch engine 1100 may include the PC inversion circuit 1110, the operation circuit 1120, the neural network model 1130, the filter circuit 1140, the buffer 1150, a first hash circuit 1160, and a second hash circuit 1170.

The first hash circuit 1160 may receive the address ADDR. The first hash circuit 1160 may perform a hash operation on the address ADDR to generate the hash address HA. For example, the first hash circuit 1160 may perform a hash operation on the address ADDR to generate the hash address HA. The hash circuit 1160 may provide the hash address HA to the operation circuit 1120. For example, a hash operation may include a folding method.

In embodiments, the first hash circuit 1160 may compress or pad the address ADDR to a first length (or a first number of bits). The first length or the first number of bits may be determined in advance. The first hash circuit 1160 may generate the hash address HA by compressing or padding the address ADDR to the first length. The hash address HA may have the first length. The hash address HA may have a first number of bits.

For example, if the address ADDR is longer than the first length, the first hash circuit 1160 may select some bits from among a plurality of bits of the address ADDR to generate the hash address HA which is compressed. If the address ADDR is shorter than the first length, the first hash circuit 1160 may generate the hash address HA with additional bits padded (or inserted) into the address ADDR.

The second hash circuit 1170 may receive the program counter PC. The second hash circuit 1170 may perform a hash operation on the program counter PC to generate a hash program counter HPC. For example, the second hash circuit 1170 may perform a hash operation on the program counter PC to generate the hash program counter HPC. The second hash circuit 1170 may provide the hash program counter HPC to the PC inversion circuit 1110. For example, a hash operation may include a folding method.

In embodiments, the second hash circuit 1170 may compress or pad the program counter PC to the first length (or a first number of bits). The first length or the first number of bits may be determined in advance. The second hash circuit 1170 may generate the hash program counter HPC by compressing or padding the program counter PC to the first length. The hash program counter HPC may have the first length. The hash program counter HPC may have the first number of bits.

For example, if the program counter PC is longer than the first length, the second hash circuit 1170 may select some bits from among a plurality of bits of the program counter PC to generate the hash program counter HPC which is compressed. If the program counter PC is shorter than the first length, the second hash circuit 1170 may generate the hash program counter HPC with additional bits padded (or inserted) into the program counter PC.

The PC inversion circuit 1110 may receive the hash program counter HPC. The PC inversion circuit 1110 may perform a bit inversion operation on the hash program counter HPC. The PC inversion circuit 1110 may perform a bit inversion operation on the hash program counter HPC to generate an inverted hash program counter INV_HPC. The PC inversion circuit 1110 may provide the inverted hash program counter INV_HPC to the operation circuit 1120.

The operation circuit 1120 may receive the hash address HA and the inverted hash program counter INV_HPC. The operation circuit 1120 may generate the input data ID by performing an XOR operation on the hash address HA and the inverted hash program counter INV_HPC. The operation circuit 1120 may transmit the input data ID to the neural network model 1130.

As described above, the prefetch engine 1100 may convert the address ADDR and the program counter PC into the hash address HA and the hash program counter HPC to have the first length. That is, a length of the hash address HA and a length of the hash program counter HPC may be the same.

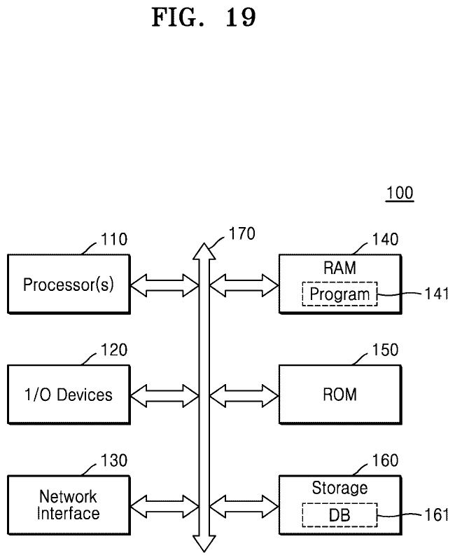

FIG. 19 is a block diagram illustrating a computing system including a memory storing a program, according to embodiments.

At least some of the operations included in the method of training a neural network model and performing data prefetch by using the neural network model may be performed by the computing system 100. In some embodiments, the computing system 100 may be referred to as a neural network system.

The computing system 100 may be a stationary computing system, such as a desktop computer, a workstation, a server, or the like, or may be a portable computing system, such as a laptop computer. As illustrated in FIG. 11, the computing system 100 may include a processor 110, input/output devices 120, a network interface 130, a random-access memory (RAM) 140, a read only memory (ROM) 150, and a storage device 160. The processor 110, the input/output devices 120, the network interface 130, the RAM 140, the ROM 150, and the storage device 160 may be connected to a bus 170 and communicate with each other through the bus 170.

The processor 110 may be referred to as a processing unit and may include at least one core capable of executing any instruction set (e.g., IA-32 (Intel Architecture-32), 64-bit extended IA-32, x86-64, PowerPC, Sparc, MIPS, ARM, IA-64, etc.), such as a microprocessor, an application processor (AP), a digital signal processor (DSP), or a graphic processing unit (GPU). For example, the processor 110 may access memory, i.e., the RAM 140 or the ROM 150, through the bus 170 and execute instructions stored in the RAM 140 or the ROM 150.

The RAM 140 may store a program 141 or at least a portion thereof for performing a method of training a neural network model and performing data prefetch using the neural network model, and the program 141 may cause the processor 110 to perform at least some of the operations included in the method of performing data prefetch by using the neural network model. That is, the program 141 may include a plurality of instructions executable by the processor 110, and the plurality of instructions included in the program 141 may cause the processor 110 to perform at least some of the operations included in the method described above. The program 141 may include the prefetch engine 1100.

The storage device 160 may not lose stored data even if power supplied to the computing system 100 is cut off. For example, the storage device 160 may include a nonvolatile memory device, or may include a storage medium such as a magnetic tape, an optical disk, or a magnetic disk. Additionally, the storage device 160 may be removable from the computing system 100. The storage device 160 may store the program 141 according to embodiments, and the program 141 or at least a portion thereof may be loaded from the storage device 160 into the RAM 140 before the program 141 is executed by the processor 110.

Alternatively, the storage device 160 may store a file written in a programming language, and the program 141 or at least a portion thereof generated by a compiler or the like from the file may be loaded into the RAM 140. Additionally, as illustrated in FIG. 19, the storage device 160 may store a database 161, and the database 161 may include information necessary to train a neural network model and perform a method of performing data prefetch by using the neural network model, such as raw data, training data, position delta maps, or labels.

The storage device 160 may store data to be processed by the processor 110 or data processed by the processor 110. That is, the processor 110 may generate data by processing data stored in the storage device 160 according to the program 141, and may also store the generated data in the storage device 160.

The input/output devices 120 may include input devices such as a keyboard, a pointing device, etc., and may include output devices such as a display device, a printer, etc. For example, a user may trigger execution of the program 141 by the processor 110, input learning data, and check result data through the input/output devices 120.

The network interface 130 may provide access to a network external to the computing system 100. For example, a network may include a number of computing systems and communication links, which may include wired links, optical links, wireless links, or any other form of links.

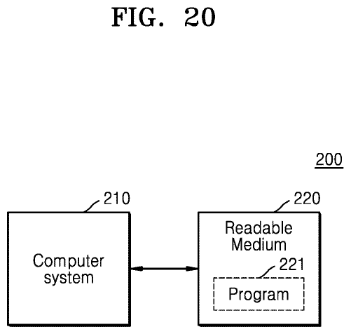

FIG. 20 is a block diagram illustrating a computing system that accesses a storage medium storing a program, according to embodiments.

At least some of the operations included in a method of performing data prefetch by using a neural network model may be performed by a computing system 200. The computing system 200 may include a computer system 210 and a readable medium 220. The computing system 200 may be the computing system 1000 described with reference to FIGS. 1 to 18.

The computer system 210 may access the readable medium 220 and execute the program 221 stored in the readable medium 220. In some embodiments, the computing system 200 may be collectively referred to as a neural network system.

The computer system 210 may include at least one computer subsystem, and the program 221 may include at least one component executed by the at least one computer subsystem. For example, at least one component may include a prefetch engine as described above with reference to the drawings. The readable medium 220 may include a nonvolatile memory device, similar to the storage device 160 of FIG. 19, and may also include a storage medium such as a magnetic tape, an optical disk, or a magnetic disk. Additionally, the readable medium 220 may be removable from the computer system 210.

The details described above are embodiments for implementing the inventive concept. The inventive concept includes not only the embodiments described above, but also embodiments that are simply designed or may be easily modified. Additionally, the inventive concept also includes techniques that may be easily modified and implemented using the embodiments. Therefore, the scope of the inventive concept should not be limited to the above-described embodiments, but should be defined not only by the claims described below but also by equivalents of the claims of the inventive concept.

While the inventive concept has been particularly shown and described with reference to embodiments thereof, it will be understood that various changes in form and details may be made therein without departing from the spirit and scope of the following claims.

What is claimed is:

1. An operating method of a computing system, the operating method comprising:
generating an inverted program counter by performing a bit inversion operation on a program counter;
generating input data by performing an XOR operation based on a first address and the inverted program counter;
performing a prefetch address prediction operation based on the input data by using a trained binary temporal convolutional neural network; and
selectively performing data prefetch from a memory device to a cache memory based on a result of the prefetch address prediction operation,
wherein the binary temporal convolutional neural network is trained based on a position delta map including an escape delta set and a proximity delta set.

2. The operating method of claim 1, wherein the performing of the prefetch address prediction operation comprises:
generating a prediction delta by inputting the input data into the trained binary temporal convolutional neural network;
when the prediction delta indicates a proximate position index, generating a prefetch address based on the prediction delta and an address; and
skipping prefetch without generating a prefetch address when the delta indicates an escape index.

3. The operating method of claim 2, wherein the generating of the prediction delta comprises:
performing a binarization operation;
performing a binary dilated causal convolution operation; and
performing an activation operation.

4. The operating method of claim 1, wherein the proximity delta set comprises weights corresponding to addresses in a range within a threshold value based on the first address, and
the escape delta set comprises a frequency corresponding to an address in a range outside the threshold value based on the first address.

5. The operating method of claim 4, wherein the weights are determined based on frequency and temporal proximity.

6. The operating method of claim 1, further comprising:
storing the input data in a buffer; and
inputting a plurality of pieces of input data stored in the buffer, into the binary temporal convolutional neural network.

7. The operating method of claim 1, wherein the performing of the prefetch address prediction operation comprises generating a first prediction delta and a second prediction delta by inputting the input data into the trained binary temporal convolutional neural network.

8. The operating method of claim 7, wherein the performing of the prefetch address prediction operation comprises:
when both the first prediction delta and the second prediction delta indicate a proximate position index, generating a first prefetch address based on the first address and the first prediction delta, and generating a second prefetch address based on the first address and the second prediction delta;
generating the first prefetch address based on the prediction delta indicating the proximate position index, and the first address, when any one of the first prediction delta and the second prediction delta indicates the proximate position index; and
not generating a prefetch address when both the first prediction delta and the second prediction delta indicate an escape index.

9. The operating method of claim 1, wherein the generating of the input data by performing an XOR operation based on the first address and the inverted program counter comprises:
generating a hash address by performing a hash operation on the first address; and
generating the input data by performing an XOR operation on the hash address and the inverted program counter.

10. The operating method of claim 1, wherein the generating of the inverted program counter comprises:
generating a hash program counter by performing a hash operation on the program counter; and
generating an inverted hash program counter by performing a bit inversion operation on the hash program counter,
wherein the generating of the input data comprises:
generating a hash address by performing a hash operation on the first address; and
generating input data by performing an XOR operation on the hash address and the inverted hash program counter.

11. The operating method of claim 1, wherein the cache memory refers to a lowest level cache.

12. A computing system comprising:
a memory device;
a cache memory;
at least one processor; and
a prefetch engine,
wherein the prefetch engine comprises:
a bit inversion circuit configured to receive a program counter and perform a bit inversion operation on the program counter to generate an inverted program counter;
an operation circuit configured to generate input data by performing an XOR operation based on the inverted program counter and a first address;
a binary temporal convolutional neural network model configured to receive the input data, perform a neural network operation based on the input data, and output a prediction delta; and
a filter circuit configured to generate a prefetch address based on the prediction delta and an address when the prediction delta indicates a proximate position index, and configured not to generate a prefetch address when the prediction delta indicates an escape index,
wherein the binary temporal convolutional neural network is trained based on a position delta map including an escape delta set and a proximity delta set, and data is loaded from the memory device to the cache memory based on the prefetch address.

13. The computing system of claim 12, wherein the binary temporal convolutional neural network model comprises:
a binarization operation module configured to perform a binarization operation on an output value of a previous loop;
a convolution operation module configured to perform a binary dilated causal convolution operation on a result value of the binarization operation module or the input data;
a weight normalization module configured to perform a weight normalization operation on a result of the convolution operation module;
a dropout module configured to probabilistically disable some neurons; and
an activation module configured to apply an activation function to an output result of the dropout module and output output data.

14. The computing system of claim 12, wherein the proximity delta set comprises weights corresponding to addresses in a range within a threshold value based on the first address, and
the escape delta set comprises a frequency corresponding to an address in a range outside the threshold value based on the first address.

15. The computing system of claim 14, wherein the weights are determined based on frequency and temporal proximity.

16. The computing system of claim 12, wherein the prefetch engine further comprises a buffer for storing input data.

17. The computing system of claim 12, wherein the cache memory refers to a lowest level cache.

18. An operating method of a computing system, the operating method comprising:
generating an inverted program counter by performing a bit inversion operation on a program counter;
generating input data by performing an XOR operation based on a first address and the inverted program counter;
generating a prediction delta based on the input data by using a trained binary temporal convolutional neural network; and
generating a prefetch address and performing data prefetch from a memory device to a cache memory based on the prefetch address, when the prediction delta indicates a proximate position index; and
skipping data prefetch when the prediction delta indicates an escape index,
wherein the binary temporal convolutional neural network is trained based on a position delta map including an escape delta set and a proximity delta set.

19. The operating method of claim 18, further comprising storing the input data in a buffer.

20. The operating method of claim 18, wherein the proximity delta set comprises weights corresponding to addresses in a range within a threshold value based on the first address, and
the escape delta set comprises a frequency corresponding to an address in a range outside the threshold value based on the first address.
